(19) United States
(12) Patent Application Publication
(10) Pub. No.: US 2011/0119724 A1
(43) Pub. Date: May 19, 2011

(54) Proxy Functionality

(75) Inventors: Ayodele Damola, Solna (SE); Jonathan Olsson, Sollentuna (SE)

(73) Assignee: TELEFONAKTIEBOLAGET LM ERICSSON (PUBL), Stockholm (SE)

(21) Appl. No.: 13/002,891

(22) PCT Filed: Jun. 7, 2008
(86) PCT No.: PCT/SE2008/050842

§ 371 Date: Jan. 6, 2011

(51) Int. Cl. H04N 7/173

(52) U.S. Cl. 725/110

(57) ABSTRACT

The present invention relates to methods and arrangement for an IPTV Set Top Box to access content from an external domain outside the IPTV service provider's domain, which method is characterized by steps of retrieving and converting required content from the external domain into a format that is accessible via the IPTV Set Top Box.

### TECHNICAL FIELD

The present invention relates to methods and arrangements for an IPTV Set-Top Box to access content from an external domain outside the IPTV service provider's domain.

### BACKGROUND

IPTV rollout is already happening and will continue to grow as high speed access technologies continue to be deployed. At the same time content aggregators, such as Joost and BBC's iPlayer, are becoming established sources of legal online content.

The increased bandwidth introduced by the penetration of broadband and the availability of enhanced terminal capabilities, content creation and publishing tools has significantly increased in availability on the Internet of user generated content, e.g. YouTube, Podcasting, etc. Content aggregators such as Joost, BBC iPlayer are also becoming established sources of legal online content.

Peer-to-peer technology has shown itself as a viable technology for distributing user generated content and technology of choice of the content aggregators. For example, the iPlayer utilizes an IMP P2P client. Often referred to simply as peer-to-peer, or abbreviated P2P, peer-to-peer architecture is a type of network in which each workstation has equivalent capabilities and responsibilities. This differs from client/server architectures where some computers are dedicated to serving the others. The P2P network distributes the computing power between connected peers in the network and utilizes the aggregated resources, e.g. network available bandwidth, for efficient content distribution. P2P is often used as a term to describe one user linking with another user to transfer information and files through the use of a common P2P client to download material, such as software upgrades or media files. This, however, is only one type of P2P networking. Generally, P2P networks are used for sharing files, but a P2P network can also mean Grid Computing or instant messaging. Once a P2P client is downloaded to and installed in for example a PC, and if connected to the internet it is possible to launch the utility and connect to a central indexing server. This central server indexes all users who are currently online connected to the server. This server does not host any files for downloading. The P2P client will contain an area where you can search for a specific file. The utility queries the index server to find other connected users with the file you are looking for. When a match is found the central server will notify the client where to find the requested file. You can then choose a result from the search query and your utility will then attempt to establish a connection with the peers hosting the file you have requested. If a successful connection is made, you will begin downloading the file. A second model of P2P clients works in the same way but without a central indexing server. In this scenario the P2P software simply seeks out other Internet users using the same program and informs them of your presence online, building a large network of computers as more users install and use the software.

IPTV specifications (e.g. OpenIPTV Forum) define architectures for supplying a variety of multimedia and interactive services to retail based consumer equipment. Two main services can be distinguished: Broadcast Content services (aka conventional TV) and On Demand content Services (aka Video on Demand). Commonly used protocols include RTSP for VoD and RTP/IGMP for live streaming. Today a majority of IPTV operators rely on delivering the video content to set-top boxes that have been subsidized to customers. Usually this is bundled with a service subscription. The aim is to be able to reach a large amount of customers (eg Telia IPTV has more than 379000 subscription as of Q1 2007) hence there is a mass roll out of STB to consumers. It is then of vital importance to the operators to keep using already deployed STBs because the cost for changing these devices could be quite high taking into account mass deployment.

As already mention, P2P technologies are widely used for file sharing, video streaming, video and content download. P2P technology has shown itself as a viable technology for distributing user generated content and technology of choice of many Internet content aggregators. The current IPTV STB deployments are however unable to utilize the new distribution methods. IPTV STBs have limited capabilities: limited execution environment capabilities i.e. not possible to cheaply add new applications such as P2P clients. The STBs may also have limited or absent storage capabilities or limited processing power. The plethora of Internet based content is currently inaccessible for ITPV STBs. Some service providers (e.g. Telia's IPTV offering) allow Web browsing using the IPTV STB, but this does not enable the users to access pure Internet based content due to format incompatibilities and simply for the absence of the right client application in the STB to perform the content download.

### SUMMARY

The present invention relates to problems caused by the Set-Top Box's limited capabilities to access content outside an IPTV service provider's domain.

These problems and others are solved by the invention by methods and arrangements for IPTV Set-Top Boxes to access content from outside the IPTV service provider's content domain. The invention specifies a network node that can be accessed by the IPTV Set-Top Boxes and that can access content from outside the IPTV service provider's content domain. In particular, but not limited to, the application specifies a way for content available in the P2P content domain and Web content domain to be accessible via the IPTV STB.

In more detail, the method comprises steps of retrieving and converting required content from the external domain into a format that is accessible via the IPTV Set-Top Box. A proxy functionality is hereby introduced which is able to fetch content from an outside the IPTV service provider's content domain, convert the content and send IPTV STBs video content using specified transport protocols, e.g. multicast—IGMP and unicast—RTSP, and media formats supported by the STBs.

An object of the invention is to define an IPTV ingestion system whereby currently deployed IPTV STBs are enabled with the capability of accessing content from emerging media content distribution networks in addition to the service provider's offering. This object and others are achieved by methods, arrangements, nodes, systems and articles of manufacture.

Some advantages with the invention are that the service provider is able to offer a better service and the end users are able to enjoy a wider variety of content using existing STBs. This extends the lifespan of existing STBs that postpones, or possibly eliminates, the investment costs of new high-end STB alternatives.

The invention will now be described more in detail with the aid of preferred embodiments in connection with the enclosed drawings.

### BRIEF DESCRIPTION OF THE DRAWINGS

FIG. 1 discloses a block schematic illustration of a system comprising a network node such as a P2P Proxy that is capable to access both an operator network and an internet network.

FIG. 2 discloses more in detail a block schematic illustration of the P2P Proxy.

FIG. 3 discloses a signal sequence diagram representing a method for the STB to fetch required content from the internet domain.

FIG. 4 discloses a block schematic illustration of a system comprising a network node such as a MCDN Proxy that is capable to access both an operator network and different MCDNs in an internet network.

FIG. 5 discloses a block schematic illustration of the MCDN Proxy.

FIG. 6 discloses a flow chart illustrating some essential method steps of the invention.

### DETAILED DESCRIPTION

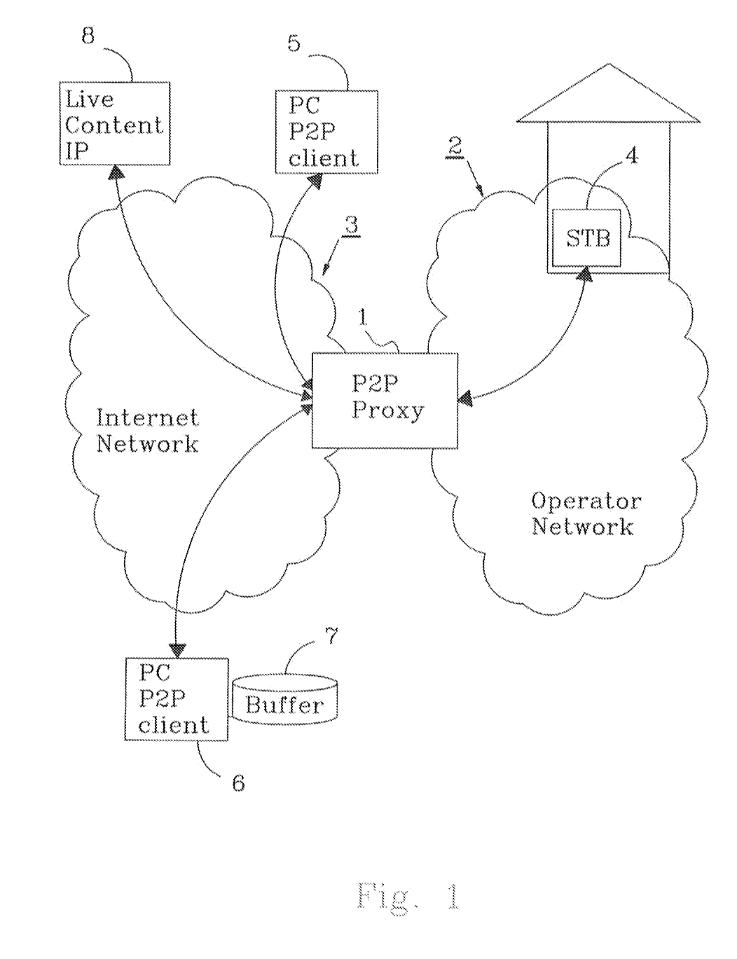

FIG. 1 discloses according to a first embodiment of the invention a content distribution system that comprises an operator's broadband network 2 and an internet network 3. The operator network 2 consists of two logical parts; a guaranteed part over which IPTV multicast traffic is delivered to STBs and a best effort part with no QoS which usually carries intent traffic. An IPTV Set-Top Box 4 can be seen within the management domain of the operator. In this example a set of assumptions is made for the IPTV STB:
No storage: currently the IPTV service provider offers the STB to user at a subsidized rate. One of the main requirements the operators place on these devices is that they be as cheap as possible, hence storage is usually lacking from such devices to keep the cost down.
No P2P applications or extra video players: due to cost issues the software on the devices is usually minimal. Also the software is usually custom built for the STBs. A common feature of both P2P applications and video players is their ever changing feature set. This then means that it becomes extremely difficult to be able to access either P2P or web content if the applications enabling this are outdated in the STB.
An assumption on legacy STBs is the support for unicast and multicast protocols. Unicast: RTSP and HTTP. Multicast: IGMP and optionally FLUTE.

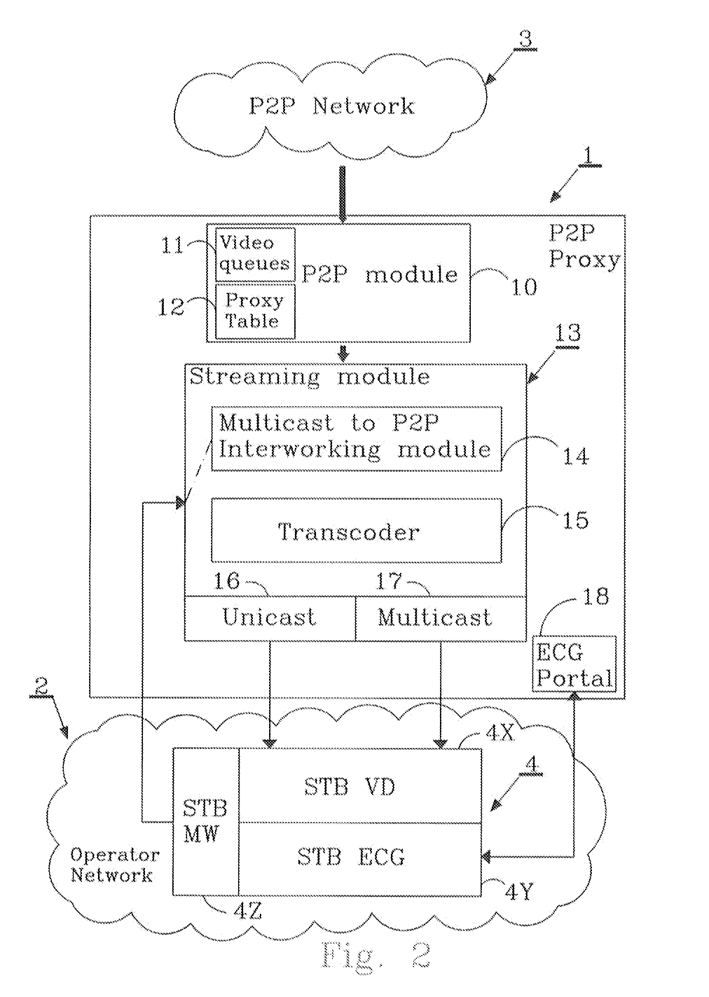

The internet network comprises a multitude set of servers. In FIG. 1 can be seen a first PC P2P client 5, a second PC P2P client 6 that is attached to a Buffer 7, and a Live Content Ingestion Point 8 into which e.g. video content can be ingested. The servers 5, 6 and 8 are in this example in a P2P relationship with each other meaning that they exchange content in a P2P fashion. A network node is disclosed in FIG. 2. The network node is in this example a P2P Proxy 1 capable to access both the internet network side and the operator network side. The proxy functionality is according to the invention able to convert and send video content fetched from the internet (from the P2P) domain, by using transport protocols (e.g. multicast—IGMP and unicast—RTSP) and media formats supported by the STBs. This will be further explained in embodiments below.

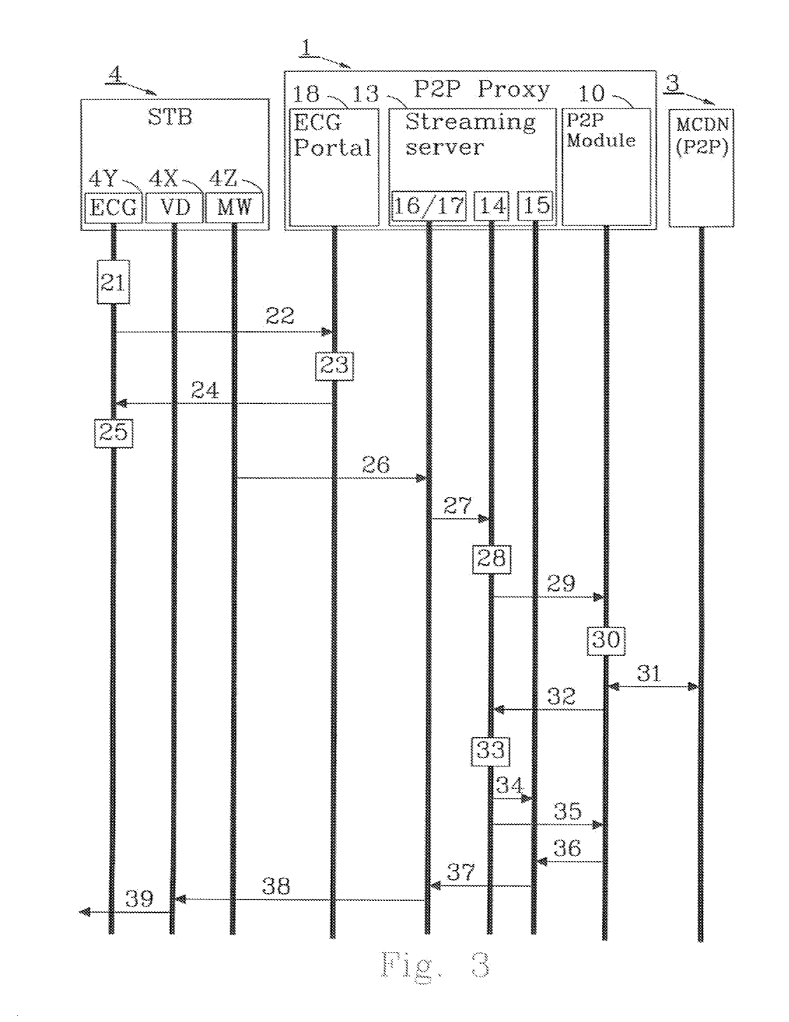

FIG. 2 discloses the peer-to-peer P2P Proxy 1 more in detail. The proxy has an interface to the open internet network, in this example to the P2P network part of the internet. The proxy 1 also has an interface to the operator network, to the STB 4. The proxy 1 is a server maintained by the service operator. The proxy 1 comprises a P2P module 10. Basically there will be multiple of this module because every module will correspond to an existing network. This will be further exemplified later in the description with a second embodiment. The P2P module comprises several video queues 11 i.e. data structure instances created in a memory of the P2P module during runtime, and a proxy table 12. Content segments that have been fetched from the P2P network will be placed in the video queues 11 and the proxy table 12 will be used to determine which distribution method (multicast or unicast) will be used to deliver the content over the managed network to the end terminal i.e. to the Set-Top Box. The P2P module is attached to a streaming module 13 that is able to do a translation between multicast and unicast protocols through P2P. The streaming module comprises an interworking module 14. The interworking module will receive a fetch request from a user of the STB (this will be further described together with FIG. 3). The fetch request will be mapped in the interworking module to a P2P request. The interworking module then performs the request out to the P2P network. The streaming module further comprises a transcoder 15 that is able to do a transcoding of received content, change the content to a format that is suitable for consumption by the Set-Top Box 4. The streaming module 13 has two casting modules, a unicast module 16 and a multicast module 17. Depending on how the Set-Top Box requested for the content, if it was a RTSP request, the streaming module will unicast the content to the STB and if the STB does an IGMP join for multicast, the streaming module will multicast the content to the Set-Top Box. The proxy 1 further comprises in this example an Electronic Content Guide ECG Portal 18. The Electronic Content Guide ECG is what the STB uses to allow the user to navigate and access traditional and new P2P content. As such the ECG will have to leverage on the existing STBs capabilities. The ECG includes dynamic content based on what is currently available on the media content distribution networks, e.g. YouTube, Joost, and iPlayer. Two methods can be used to generate the ECG: static or on-demand. A statically generated ECG will pre-crawl content sites and index the content that is available at each site. This may be done periodically to keep the ECG updated. The on-demand method may utilize standardized interfaces, such as Web services, towards content sites to access content listings each time the user want to access it. This ensures that the ECG content is always up to date. Both methods will utilize predefined interfaces that the ECG Server can use to query Media Content Distribution Networks MCDNs or allow the MCDNs to push updates to the ECG Server. The details of these interfaces are outside the scope of this patent, but could utilized standardized interfaces, such as Web Services. The STB 4 comprises an STB Video Decoder STB VD 4X, an STB Electronic Content Guide STB ECG 4Y capable to receive information from the ECG portal, and an STB Middleware STB MW from where user requests are sent to the interworking module.

To summarize, the P2P proxy 1 has a set of interfaces; an external set towards the P2P network and an internal set and transcoding functionality between the interfaces. The external set of interfaces constitutes software clients of the different content distribution networks that the operator wishes to connect to. For example clients could include; BittorentDNA client, Naspter client and other P2P application clients. The internal interfaces constitute modules enabling content delivery using traditional methods including RTP over IGMP for multicast and RTSP for unicast. The transcoding functionality in the Transcoder 15 enables content received on the external interface to be sent out on the internal interface. The functionality consists of a set of rules that describe how content from a specific P2P application is firstly transcoded to a given media format and then distributed to the STBs via standard transport protocol. Hence the proxy consists of a set of media decoders and encoders. The P2P proxy does media transcoding taking into account parameters such as: bitrate, resolution, and codec.

FIG. 3 discloses signal sequence diagram representing a method for the STB to fetch required content from the internet domain. The entities disclosed in FIG. 3 have all been explained together with the explanation of FIGS. 1 and 2. A Media Content Distribution Network MCDN corresponds to the P2P Network in FIG. 2. A method according to a first embodiment of the invention will now be described more in detail together with FIG. 3. FIG. 3 is to be read together with FIG. 2. The method comprises the following steps:
A user switches on 21 the Set-Top Box 4.
The ECG client 4Y in the STB 4 performs a fetch operation 22 for content of the Electronic Content Guide ECG portal 18. A fetch request is hereby sent from the STB to the P2P Proxy 1. Optionally the identity of the user is included.
The electronic content guide is generated 23 in the ECG portal as described earlier in this application. Optionally the identity of the user can be used for personalization.
The ECG data is delivered 24 from the P2P Proxy 1 to the STB 4. The ECG data comprises a list of available assets.
The user selects 25 content from the list of available assets. Alternatively the search procedure, as have been mentioned earlier, can be performed here.
The user selection in the previous step would result in either a multicast or unicast fetch request command (e.g. IGMP join for multicast, RTSP Play or HTTP GET for unicast). In the case where the user made a search rather than selecting from a predefined set of content, this step would occur only after a successful discovery of the requested video asset. The significance of this step is that it utilizes the existing content retrieval methods that are currently implemented on STBs today. A unicast fetch request is in this example sent 26 from the middleware MW 4Z in the STB 4 to the unicast/multicast module 16/17 in the streaming module. The fetch request comprises, beyond information about desired casting method, also additional metadata for example information such as desired media format e.g. bitrate, encoding etc.
A request 27 to retrieve the required content is sent from the unicast/multicast module 16/17 to the Interworking module 14. An internal message is hereby sent from the unicast/multicast module 16/17 to the Interworking module 14. This signals the interworking module to translate between requests for content and Media Content Distribution Network MCDN specific methods. It is a trigger message signaling the interworking module that the STB has made a request and that the interworking module should translate the request into a P2P request (i.e a message 29 that can be seen in FIG. 3) to be sent to the P2P module.
A session ID is generated 28 in the interworking module 14 to identify the present session. The session ID is used to identify data that later will be retrieved from the Media Content Distribution Network MCDN so that the request from the user can be brought together with actual retrieval of the content from MCDN. The Interworking module 14 keeps the session state information to determine if received content e.g. a video is to be sent as unicast or multicast to the STB.
The Interworking Module sends 29 a message containing the session ID, content name, and additional metadata such as bitrate, encoding etc. to the P2P module 10 for processing. The additional metadata is in this example received in the fetch request but a possible variation would be to have it pre-stored in the P2P proxy.
The P2P module uses 30 the data in the message from the Interworking Module 14 to instantiate a data queue in the video queues 11 and an entry in the Proxy Table 12 including the session ID, a pointer to the data queue, and additional information i.e metadata that was received in Step 9 or that may be used when managing the content retrieval process.
A negotiation 31 is performed between the P2Pmodule 10 and the MCDN, resulting in that content is downloaded 31 from the MCDN and placed in the video queues 11. The method used to download the content, e.g. from multiple sources or a single source, will determine how the data queue is populated. Data might for example be queued until the whole content is received before distribution to the user takes place or data might be distributed to the user during the downloading.
The Interworking Module 14 is notified 32 that the content is downloaded. This notification is coupled with the session ID. There are two alternatives for this step. The choice of which alternative to use may be dictated by policies in the P2P proxy. Either the P2P module sends notifies when the content has been entirely downloaded or it notifies when individual segments of the content have downloaded. Since the content will be streamed to the end user, if the second alternative is used then it is assumed that the notification will be for sequential segments.
The interworking function uses the session ID to determine 33 whether the content needs to be transcoded i.e converting the video signal into another one with different format, such as different bit rate, frame rate, frame size, or even compression standard and whether the stream towards the customer will be unicast or mulicast. In this example the stream will be unicast.
Transcoding details are sent 34 to the transcoder 15 together with a pointer to the video queues 11 to the content that is to be transcoded.
An order is sent 35 from interworking module 14 to the P2P module, requesting the P2P module, that remaing video sequences are to be sent directly to the transcoder 15.
The transcoder 15 will get 36 the content to be transcoded from the P2P module data queue in the video queues 11. This data is then transcoded from its original format to the appropriate format for the STB and originating request. Exception: in some cases the content may already be in the correct format, whereby the Transcoder will only retrieve the content and will not manipulate the content.
The content is sent 37 to the Unicast/Multicast Module 16/17.
The Unicast/Multicast Module will stream 38 the content to the STB decoder. In this example the content will be unicasted.
The content is decoded by the STB to be displayed 39.

To be noted is that the signalling shown above is an example and that variations are possible.

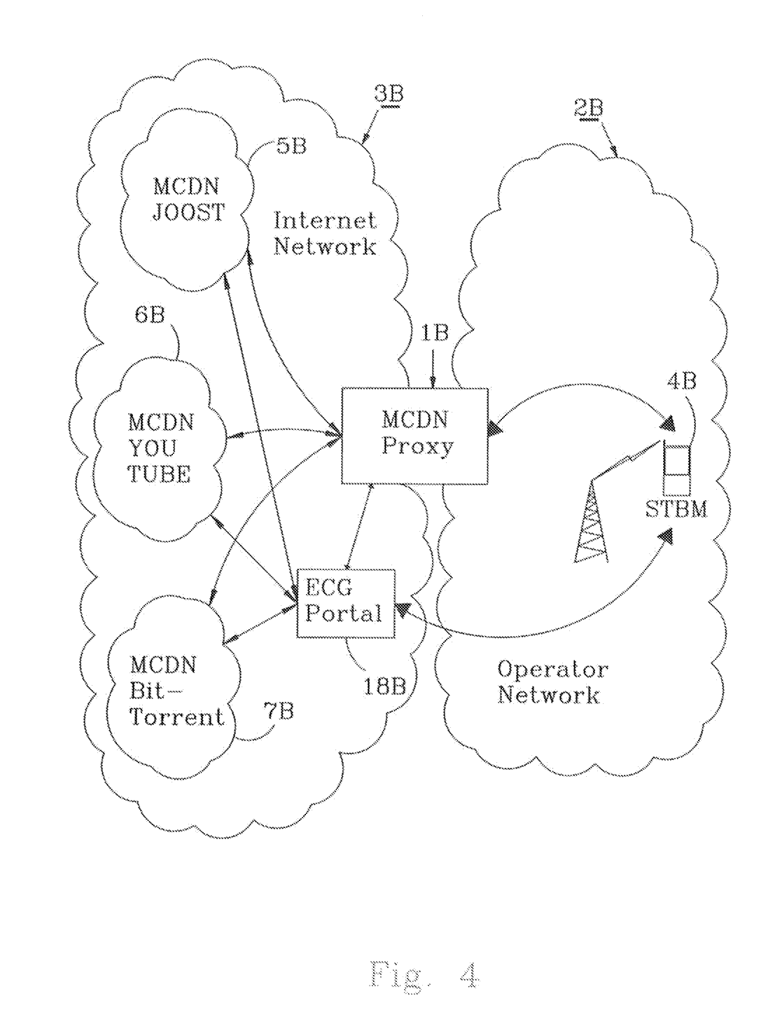

FIG. 4 discloses in a second embodiment of the invention a content distribution system that comprises an operator's broadband network 2B and an internet network 3B. A mobile IPTV Set-Top Box 4B can be seen within the management domain of the operator. The internet network comprises in this example, but is not limited to, different Media Content Distribution Networks MCDN such as Joost 5B, You Tube 6B and BitTorrent 7B. A network node is disclosed in FIG. 4. The network node is a MCDN Proxy 1B that is capable to access both the internet network side and the operator network side. The proxy functionality is according to the invention in this example able to convert and send video content fetched from the Joost-, You Tube-, BitTorrent-domain. An Electronic Content Guide ECG Portal 18B is in this embodiment located outside the MCDN Proxy. The ECG is what the legacy STB uses to allow the user to navigate and access traditional and new content (in this example Joost-, You Tube-, BitTorrent-content). As such the ECG will have to leverage on the existing STBs capabilities. As mentioned before, two methods can be used to generate the ECG: static or on-demand. Both methods will utilize predefined interfaces that the ECG Server can use to query the MCDNs or allow the MCDNs to push updates to the ECG Server.

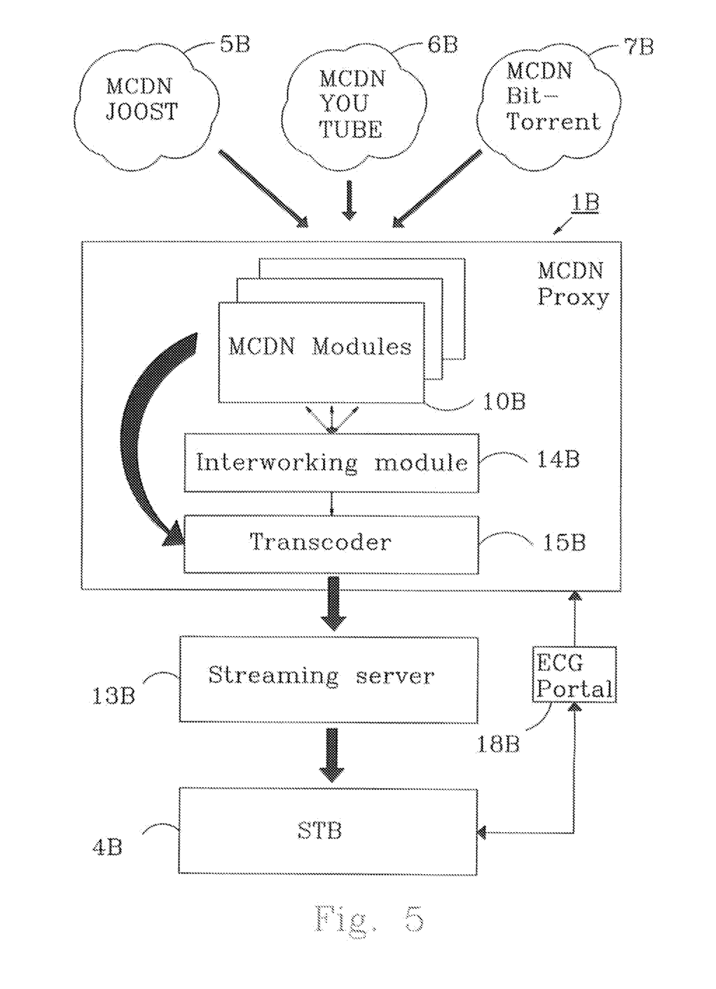

FIG. 5 discloses schematically the MCDN Proxy 1B. The proxy has an interface to the open internet network, in this example to the Joost-, You Tube-, BitTorrent-parts of the internet. The proxy 1B also has an interface to a streaming server that is capable to deliver content to the STB 4B using a suitable transport protocol, for example multicast or unicast. The ECG Portal 18B is located between the MCDN Proxy and the STB 4B.

The proxy 1B comprises an MCDN module 10B. Actually, as can be seen in FIG. 5 the MCDN module in this example comprises three different modules: a Joost module, a You Tube module and a BitTorrent module. Every module corresponds to one of the existing networks. Each MCDN module's functionality corresponds to the P2P module that has been explained earlier in FIG. 2. Each MCDN module is attached to an Interworking module 14B that in turn is attached to a Transcoder 15B. The Interworking module and the Transcoder both have the same functionality as the, in FIG. 2, previous explained corresponding entities. The MCDN Proxy is attached via the Transcoder to a Streaming server 17B which in turn is attached to the STB 4B. Like in the first embodiment, the interworking module will receive a fetch request from a user of the STB 4B. The fetch request will be mapped in the interworking module to a Joost-, You Tube- or a BitTorrent request. The interworking module then performs the request out to the network in question. The Transcoder 15B enables content received on the external interface to be sent out on the internal interface. The transcoding functionality consists of a set of rules that describe how content from a specific application Joost, You Tube or BitTorrent is firstly transcoded to a given media format and then distributed to the STB via standard transport protocol. The Streaming server 17B may comprise one or two modules, a unicast module and/or a multicast module. Depending on how the Set-Top Box requested for the content, if it was a RTSP request, the streaming server will unicast the content to the STB and if the STB does an IGMP join for multicast, the streaming server will multicast the content to the Set-Top Box. The ECG Portal is attached to the STB 4b and to the MCDN Proxy. There must be a relationship between the ECG and the Proxy. The ECG maintains a link to each content item. After a content request from the STB to the ECG, the link specification is forwarded from the STB to the MCDN Proxy as part of the request (e.g. in RTSP PLAY command). As an alternative, the ECG may specify links to content to the MCDN Proxy.

A rudimentary example of a signal sequence used by the STB 4B to fetch required content from the internet domain may be like this:
After the STB has received available content from the ECG, the user selects desired content to be downloaded. In this example content from MCDN Joost is selected.
A fetch request is sent from the STB 4B to the Interworking module 14B in the MCDN Proxy 1B.
A session ID is generated in the interworking module 14B to identify the present session.
The Interworking Module 14B sends a message containing the session ID, content name, and additional metadata to the MCDN Joost module 10B for processing.
A data queue and an entry in a Proxy Table is instantiated in the MCDN Joost module 10B.
Content is downloaded from the MCDN Joost network and placed in the MCDN Joost module 10B.
The Interworking Module 14B is notified that the content is downloaded.
Transcoding details are sent from the Interworking module 14B to the Transcoder 15B together with a pointer to the content that is to be transcoded.
An order is sent from interworking module 14B to the MCDN Joost module 10B, requesting the module, that video sequences are to be sent directly to the transcoder 15B.
Data received to the transcoder 15B is transcoded from its original format to the appropriate format for the STB 4B and originating request.
The content is sent to the Steaming server 17B.
The Streaming server streams the content to the STB 4B and the content will be displayed.

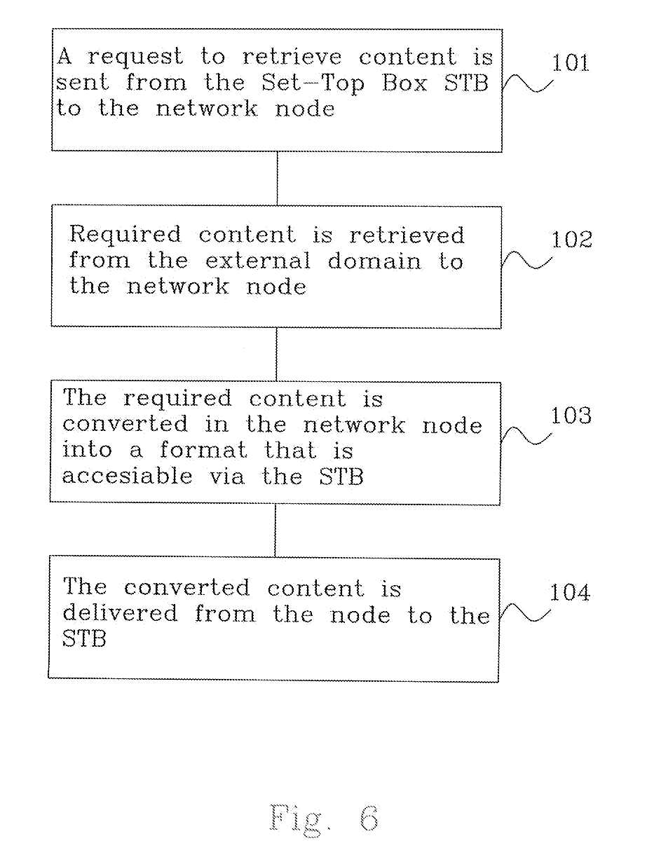

FIG. 6 discloses a flow chart illustrating some essential method steps of the invention. The flow chart is to be read together with the earlier shown figures. The flow chart comprises the following steps:
A request to retrieve content from an external domain is received from a Set-Top Box to a network node. This step is shown in the figure with a block 101.
The required content is retrieved from the external domain to the network node. This step is shown in the figure with a block 102.
The required content is converted in the network node into a format that is accessible via the Set-Top Box. This step is shown in the figure with a block 103.
The converted content is delivered from the network node to the Set-Top Box. This step is shown in the figure with a block 104.

Node and systems that can be used to put the invention into practice have been shown in FIGS. 1,2,4 and 5. Enumerated items are shown in the figures as individual elements. In actual implementations of the invention, however, they may be inseparable components of other electronic devices such as a digital computer (processor). Thus, actions described above may be implemented in software that may be embodied in an article of manufacture that includes a program storage medium. The program storage medium includes data signal embodied in one or more of a carrier wave, a computer disk (magnetic, or optical (e.g., CD or DVD, or both), non-volatile memory, tape, a system memory, and a computer hard drive.

The invention is not limited to the above described and in the drawings shown embodiments but can be modified within the scope of the enclosed claims. The systems and methods of the present invention may be implemented for example on any of the Third Generation Partnership Project (3GPP), European Telecommunications Standards Institute (ETSI), American National Standards Institute (ANSI) or other standard telecommunication network architecture. Other examples are the Institute of Electrical and Electronics Engineers (IEEE) or The Internet Engineering Task Force (IETF) or The Broadband Forum.

The description, for purposes of explanation and not limitation, sets forth specific details, such as particular components, electronic circuitry, techniques, etc., in order to provide an understanding of the present invention. But it will be apparent to one skilled in the art that the present invention may be practiced in other embodiments that depart from these specific details. In other instances, detailed descriptions of well-known methods, devices, and techniques, etc., are omitted so as not to obscure the description with unnecessary detail. Individual function blocks are shown in one or more figures. Those skilled in the art will appreciate that functions may be implemented using discrete components or multi-function hardware. Processing functions may be implemented using a programmed microprocessor or general-purpose computer. The invention is not limited to the above described and in the drawings shown embodiments but can be modified within the scope of the enclosed claims.

The invention is of course not limited to the above described and in the drawings shown embodiments but can be modified within the scope of the enclosed claims.

1. A method for an IPTV Set Top Box to access content from an external domain outside the IPTV service provider's domain, wherein the method comprises the following steps:
receiving from the Set-Top Box to a network node, a fetch request to retrieve required content from the external domain, which request further comprises specified content delivering details;
retrieving the required content, from the external domain to the network node;
converting in the node the required content from the external domain by performing the delivering details, into a format that is accessible via the Set-Top Box;
delivering from the node, the converted content to the IPTV Set-Top Box.

2. The method for an IPTV Set-Top Box to access content according to claim 1 whereby the required content is downloaded from a Media Content Distribution Network (MCDN) in the external domain and wherein the fetch request is translated in the network node to a format suitable for the Media Content Distribution Network (MCDN).

3. The method for an IPTV Set-Top Box to access content according to claim 1 whereby the delivering details comprise transcoding specifications, such as multicast or unicast.

4. The method for an IPTV Set-Top Box to access content according to claim 1 whereby the delivering details comprise required content format suitable for the Set-Top Box, such as bitrates, resolution, or codec.

5. The method for an IPTV Set-Top Box to access content according to claim 4 wherein at least parts of the delivering details have been pre-stored in the network node.

6. The method for an IPTV Set-Top Box to access content according to claim 1, which method comprises the following further step:
generating in the node a session ID to be used to identify a session resulting from an internal signalling request for content from a Media Content Distribution Network (MCDN).

7. The method for an IPTV Set-Top Box to access content according to claim 6 wherein the session ID is used in the network node to put together the session with delivering details and content format.

8. The method for an IPTV Set-Top Box to access content according to claim 6, which method comprises the following further step:
instantiating an entry in a table in the network node, including the session ID and a pointer to an initiated data queue.

9. An arrangement suitable for an IPTV Set Top Box to access content from an external domain outside the IPTV service provider's domain, which arrangement comprises:
means for receiving from the Set-Top Box to a network node, a fetch request to retrieve required content from the external domain, which request further comprises specified content delivering details;
means for retrieving the required content, from the external domain to the network;
means for converting in the node the required content from the external domain by performing the delivering details, into a format that is accessible via the Set-Top Box;
means for delivering from the node, the converted content to the IPTV Set-Top Box.

10. The arrangement suitable for an IPTV Set-Top Box to access content according to claim 9 whereby the required content is downloaded from a Media Content Distribution Network (MCDN) in the external domain and wherein the fetch request is translated in the network node to a format suitable for the Media Content Distribution Network (MCDN).

11. The arrangement suitable for an IPTV Set-Top Box to access content according to claim whereby the delivering details comprise transcoding specifications, such as multicast or unicast.

12. The arrangement suitable for an IPTV Set-Top Box to access content according to claim 9, whereby the delivering details comprise required content format suitable for the Set-Top Box, such as bitrates, resolution, or codec.

13. The arrangement suitable for an IPTV Set-Top Box to access content according to claim 12 wherein at least parts of the delivering details have been pre-stored in the network node.

14. The arrangement suitable for an IPTV Set-Top Box to access content according to claim 9, which arrangement further comprises:
means for generating in the node a session ID to be used to identify a session resulting from an internal signalling request for content from a Media Content Distribution Network (MCDN).

15. The arrangement suitable for an IPTV Set-Top Box to access content according to claim 14 wherein the session ID is used in the network node to put together the session with delivering details and content format.

16. The arrangement suitable for an IPTV Set-Top Box to access content according to claim 14, which arrangement further comprises:
means for instantiating an entry in a table in the network node, including the session ID and a pointer to an initiated data queue.

17. A network node suitable for an IPTV Set-Top Box to access content from an external domain outside the IPTV service provider's domain, comprising:
means for receiving a request to retrieve content from the external domain, which request further comprises specified content delivering details;
means for retrieving the required content from the external domain;
means for converting required the content from the external domain by performing the delivering details, into a format that is accessible via the Set-Top Box;
means for delivering from the node, the converted content.

18. A computer program loadable into a processor of a network node, wherein the computer program comprises code adapted to perform the method of claim 1.
